(19) United States
(12) Patent Application Publication
(10) Pub. No.: US 2014/0313002 A1
(43) Pub. Date: Oct. 23, 2014

(54) NONLINEAR INDUCTOR

(71) Applicant: DELTA ELECTRONICS, INC., Taoyuan Hsien (TW)

(72) Inventors: Tsung-Nan KUO, Taoyuan Hsien (TW); Ming-Xian LI, Taoyuan Hsien (TW)

(73) Assignee: DELTA ELECTRONICS, INC., Taoyuan Hsien (TW)

(21) Appl. No.: 14/084,873

(22) Filed: Nov. 20, 2013

(30) Foreign Application Priority Data
Apr. 19, 2013 (TW) 102114018

(51) Int. Cl. H01F 27/24

(52) U.S. Cl. CPC H01F 27/24
USPC 336/178; 336/221

(57) ABSTRACT

A non-linear inductor is disclosed herein. The non-linear inductor includes a first magnetic core, a second magnetic core, a third magnetic core, a fourth magnetic core, a fifth magnetic core and a coil unit. The first and the second magnetic core are disposed in parallel. The third magnetic core, the fourth magnetic core and the fifth magnetic core are all vertically disposed between the first and the second magnetic core. The fourth magnetic core is vertically disposed between the first and the second magnetic core. The fourth and the fifth magnetic core are disposed at both sides of the third magnetic core in parallel. The coil unit winds around the third magnetic core. A magnetic resistance of the fourth magnetic core passed through by an inductive magnetic flux is different from a magnetic resistance of the fifth magnetic core passed through by the inductive magnetic flux.

### RELATED APPLICATIONS

This application claims priority to Taiwan Application Serial Number 102114018, filed Apr. 19, 2013, which is herein incorporated by reference.

### BACKGROUND

1. Field of Invention

The present invention relates to an inductor. More particularly, the present invention relates to a nonlinear inductor with a set of the asymmetrical magnetic resistance.

2. Description of Related Art

In an electrical system driven by a variable-frequency drive (VFD), there are signals switching in high frequency existing in the circuitry of the VFD and the motor, which may result in unnecessary electromagnetic interference, so as to reduce the power factor of the VFD and generate a harmonic distortion on the output loading.

The total harmonic distortion is even higher when the VFD is at low current operation. If the harmonic distortion is too high, the performance of the system may be reduced, and the devices in the system may even be damaged. To reduce the harmonic distortion, a nonlinear inductor is commonly connected to the VFD in series.

In general, a nonlinear inductor with the higher inductance may scientifically reduce the harmonic distortion. But if the inductance is too high, the voltage drops in the output terminals of the VFD at the high current operation. Therefore, the nonlinear inductor is generally used to achieve the feature of the high inductance at the low current operation and the low inductance at the high current operation that satisfy the inductance requirements at the low or the high current operation.

The shape variation of the air gaps, which is build with the extra mold opening, is often applied to implement the nonlinear inductor; however, such shape variation need additional molds in fabrication and thus extra cost.

### SUMMARY

One aspect of this invention provides a nonlinear inductor, which has multiple ways to adjust the inductance without the extra mold opening to achieve the adjustment of the inductance in the different applications.

The nonlinear inductor includes a first magnetic core, a second magnetic core, a third magnetic core, a fourth magnetic core, a fifth magnetic core and a coil unit. The second magnetic core is disposed in parallel with the first magnetic core. The third magnetic core, the fourth magnetic core and the fifth magnetic core are vertically disposed between the first magnetic core and the second magnetic core. The fourth magnetic core and the fifth magnetic are disposed at the sides of the third magnetic core. The coil unit winds over the third magnetic core, wherein a DC current passes through the coil unit to generate an inductive magnetic flux, a first magnetic resistance of the fourth magnetic core passed through by the inductive magnetic flux is different from a second magnetic resistance of the fifth magnetic core passed through by the inductive magnetic flux.

According to one embodiment of the present invention, a first air gap respectively exists between the fourth magnetic core and the first magnetic core and between the fourth magnetic core and the second magnetic core, and a second air gap respectively exists between the fifth magnetic core and the first magnetic core and between the fifth magnetic core and the second magnetic core, wherein the width of the first air gap and the second air gap is different, thereby forming the different first magnetic resistance and the second magnetic resistance.

According to one embodiment of the present invention, a third air gap respectively exists between the third magnetic core and the first magnetic core and between the third magnetic core and the second magnetic core, wherein the first air gaps are wider than the third air gaps, and the third air gaps are wider than the second air gaps.

According to another embodiment of the present invention, a first air gap exists between the fourth magnetic core and the second magnetic core, and a second air gap exists between the fifth magnetic core and the second magnetic core, the width of the first air gap is different from the width of the second air gap, thereby forming the different first magnetic resistance and the second magnetic resistance.

According to aforementioned embodiment of the present invention, the third magnetic core, the fourth magnetic core and the fifth magnetic core are directly connected to the first magnetic core, and a third air gap exists between the third magnetic core and the second magnetic core, wherein the first air gap is wider than the third air gap, and the third air gap is wider than the second air gap.

According to one embodiment of the present invention, the cross-sectional area of the fourth magnetic core is different from the cross-sectional area of the fifth magnetic core, thereby forming the different first magnetic resistance and the second magnetic resistance.

According to one embodiment of the present invention, the third magnetic core is made of grain-orient electrical steel sheets, and the first magnetic core, the second magnetic core, the fourth magnetic core and the fifth magnetic core are made of non-orient electrical steel sheets.

In summary, the nonlinear inductor in the embodiments of the present invention has multiple ways to adjust the inductance without the extra mold opening to achieve the high inductance at the low current operation and the low inductance at the high current operation.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a nonlinear inductor according to one embodiment of the present invention;

FIG. 2 is a configuration diagram of the nonlinear inductor shown in FIG. 1 according to one embodiment of the present invention;

FIG. 3 is a diagram of the relation between the effective inductance and the current in the nonlinear inductor in the FIG. 2;

FIG. 4 is the diagram of the corresponding equivalent magnetic circuit model according to the nonlinear inductor 200 as shown in FIG. 2;

FIG. 5A is another configuration diagram of the nonlinear inductor as shown in FIG. 1 according to another embodiment in the present invention;

FIG. 5B is a diagram of the relation between the effective inductance and the current in the nonlinear inductor in the FIG. 5A;

FIG. 6A is another configuration diagram of the nonlinear inductor as shown in FIG. 2 according to another embodiment in the present invention;

FIG. 6B is a diagram of the relation between the effective inductance and the current in the nonlinear inductor in the FIG. 6A;

FIG. 7A is another configuration diagram of the nonlinear inductor as shown in FIG. 1 according to another embodiment in the present invention; and

FIG. 7B is a diagram of the relation between the effective inductance and the current in the nonlinear inductor in the FIG. 7A.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

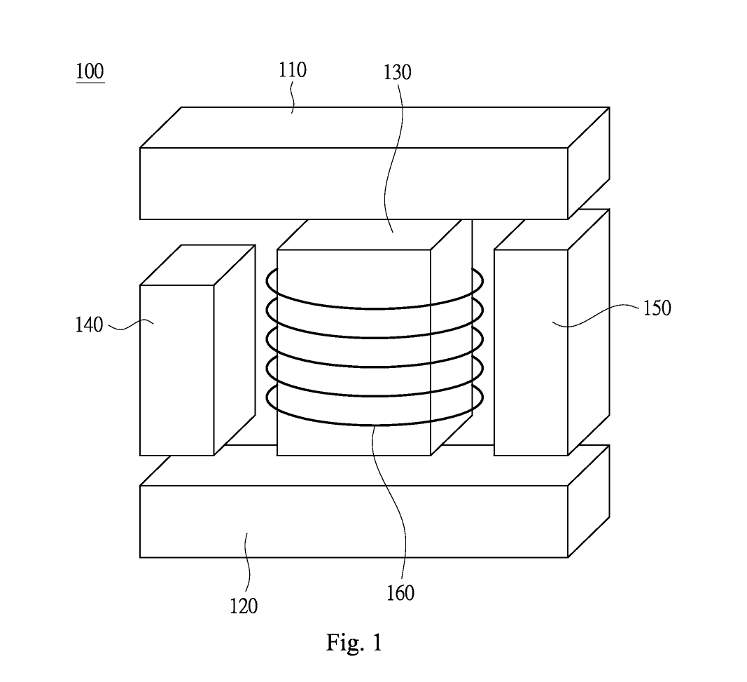

FIG. 1 is a nonlinear inductor according to one embodiment of the present invention. As shown in FIG. 1, the nonlinear inductor 100 includes a first magnetic core 110, a second magnetic core 120, a third magnetic core 130, a fourth magnetic core 140, a fifth magnetic core 150 and a coil unit 160. The second magnetic core 120 is dispose in parallel with the first magnetic core 110. The third magnetic core 130, the fourth magnetic core 140 and the fifth magnetic core 150 are vertically disposed between the first magnetic core 110 and the second magnetic core 120. The fourth magnetic core 140 and the fifth magnetic 150 are disposed at the sides of the third magnetic core 130. The coil unit 160 may be a multi-turn coil. The coil unit 160 winds around the third magnetic core 130. When a DC current passing through the coil unit 160, an inductive magnetic flux will be generated, wherein an effective magnetic resistance of the fourth magnetic core 140 (denoted as a first magnetic resistance) passed through by the inductive magnetic flux is different from an effective magnetic resistance of the fifth magnetic core 150 (denoted as a second magnetic resistance) passed through by the inductive magnetic flux. Due to the total effective inductance of the nonlinear inductor 100 is related to the first magnetic resistance of the fourth magnetic core 140 and the second magnetic resistance of the fifth magnetic core 150, the inductance of the nonlinear inductor 100 can be flexibly adjusted by adjusting the first resistance and the second resistance.

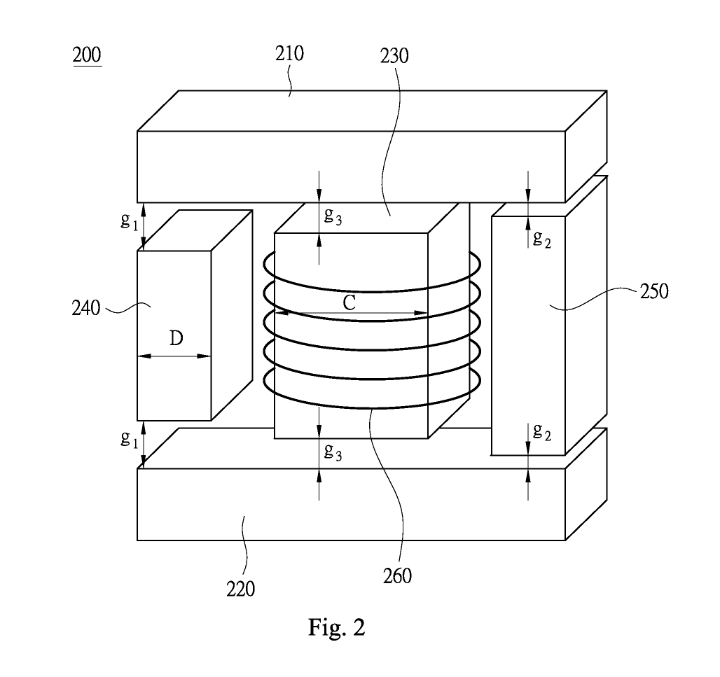

The following paragraphs will discuss some embodiments about the different first magnetic resistance and the second magnetic resistance in this invention. Referring to FIG. 2, FIG. 2 is a configuration diagram of the nonlinear inductor shown in FIG. 1 according to one embodiment of the present invention. All parts in the FIG. 2 are corresponding to the parts in the FIG. 1. Notably, as shown in FIG. 2, a first air gap g₁ respectively exists between the fourth magnetic core 240 and the first magnetic core 210 and between the fourth magnetic core 240 and the second magnetic core 220, and a second air gap g₂ respectively exists between the fifth magnetic core 250 and the first magnetic core 210 and between the fifth magnetic core 250 and the second magnetic core 220. The width of the first air gap g₁ is different from the width of the second air gap g₂. An inductive magnetic flux passed through the fourth magnetic core 240 has to cross the first air gaps g₁, and the inductive magnetic flux passed through the fifth magnetic core 250 has to cross the second air gaps g₂ with the different width, thereby forming the different first magnetic resistance and the second magnetic resistance.

Moreover, as shown in FIG. 2, a third air gap g₃ respectively exists between the third magnetic core 230 and the first magnetic core 210 and between the third magnetic core 230 and the second magnetic core 220.

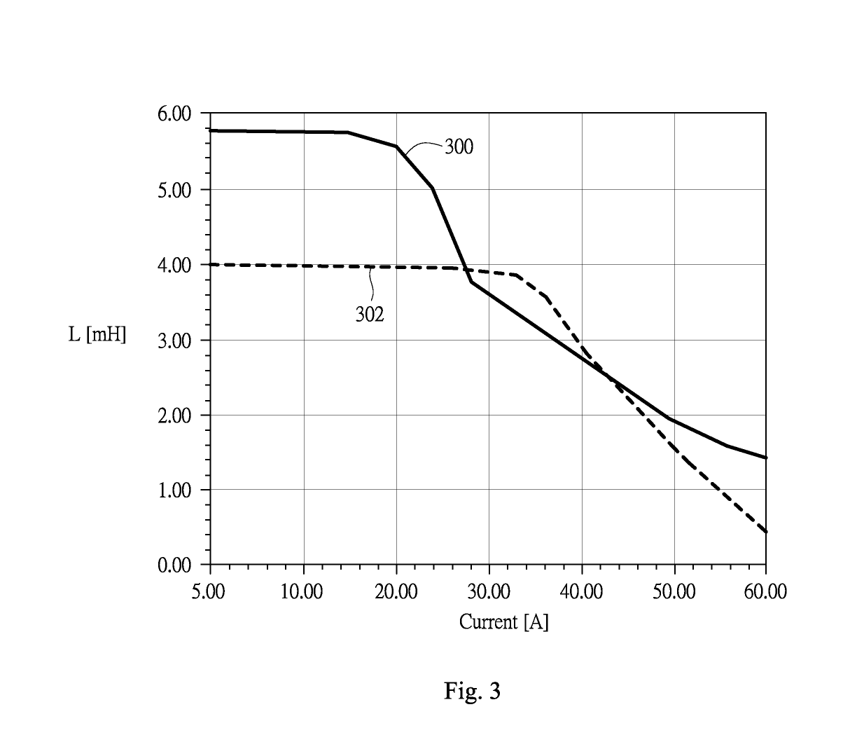

In one embodiment, the width of the aforementioned first air gap g₁ is wider than the width of the third air gap g₃, and the width of the third air gap g₃ is wider than the width of the second air gaps g₂. For example, the width of the first air gap g₁ may be about 0.9 millimeter (mm), the width of the second air gap g₂ may be about 0.225 mm, and the width of the third air gap g₃ may be about 0.45 mm. The corresponding diagram of the relation between the effective inductance and the current in this example is shown as the curve 300 with the solid line in the FIG. 3. The curve 302 with dotted line, used for comparison purpose, is represented as the performance of a common inductor. In contrast, the nonlinear inductor 200 with the different first magnetic resistance and the second magnetic resistance formed by the different widths of the air gaps, g₁ and g₂ respectively, may increase the effective inductance (about 5.78 mH) at the low current operation. The nonlinear inductor 200 may have a larger saturation magnetic flux quantity at the high current operation, and thus the nonlinear inductor 200 can be applied in higher current operation range.

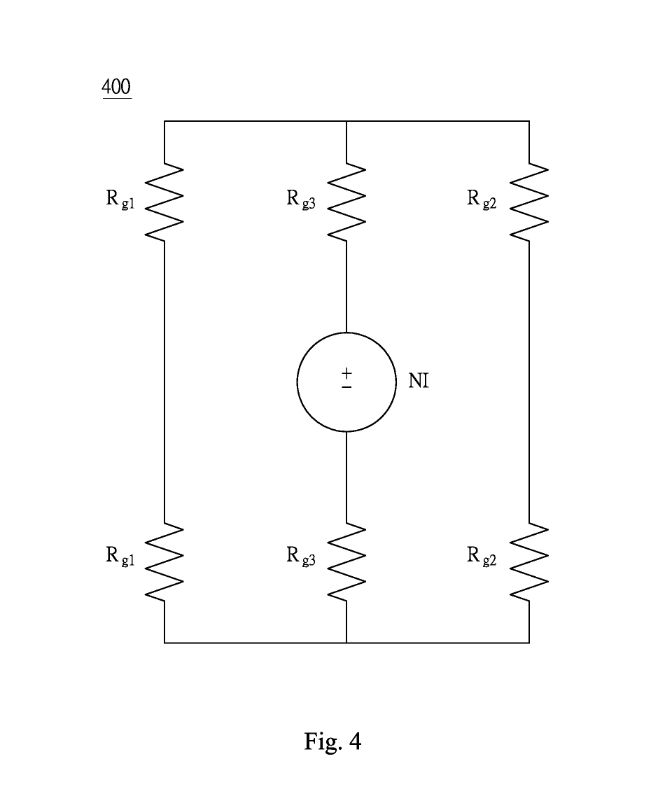

Furthermore, we can analyze the nonlinear inductor 200 as shown in FIG. 2 by using the equivalent magnetic circuit model. Referring to FIG. 4, FIG. 4 is the diagram of the corresponding equivalent magnetic circuit model according to the nonlinear inductor 200 as shown in FIG. 2. The magnetomotive force NI as shown in FIG. 4 is corresponding to the N turns coil of the coil unit 260 and the current I which is passed through the coil unit 260 as shown in FIG. 2, and the R_{g1}, R_{g2}, R_{g3} is respectively corresponding to the effective magnetic resistance of the first air gap g₁, the second air gap g₂, and the third air gap g₃. We can derive the effective magnetic resistance Rₜₒₜₐₗ of the nonlinear inductor 200 as Rₜₒₜₐₗ=2R_{g3}+2 (R_{g1}∥R_{g2}). Due to the width of the air gap is in proportion to the magnetic resistance, taking the FIG. 2 as example, the width of the first air gap g₁ is wider than the width of the third air gap g₃, and the width of the third air gap g₃ is wider than the width of the second air gap g₂, the corresponding relationship of the magnetic resistance is: R_{g1}>R_{g3}>R_{g2}. Because the effective magnetic resistance R_{g1} of the first air gap g₁ is higher, the inductive magnetic flux generated from the third magnetic core 230 and the coil unit 260 is most passing through the R_{g2} at the low current operation, which means that the density of the magnetic flux of the fifth magnetic resistance 250 is higher than the magnetic flux of the fifth magnetic resistance 240. At this case, the effective magnetic resistance Rₜₒₜₐₗ of the nonlinear inductor 200 can be modified to Rₜₒₜₐₗ≈2R_{g3}+2R_{g2}. In other words, at the low current operation, the effective inductance of the nonlinear inductor 200 is more related to the effective magnetic resistance R_{g2} of the second air gap g₂.

Further, when the nonlinear inductor 200 operates at the high current operation, the magnet flux can be received by the fifth magnetic core 250 towards saturation, the corresponding effective magnetic resistance R_{g2} becomes higher, the magnet flux generated from the third magnetic core 203 and the coil unit 260 begin passing through the R_{g1}, that is, the density of the fourth magnetic core 240 is increasing. At this case, the effective magnetic resistance Rₜₒₜₐₗ of the nonlinear inductor 200 can be modified to: Rₜₒₜₐₗ≈2R_{g3}+2R_{g1}. In summary, at the high current operation, the effective inductance of the nonlinear inductor 200 is more related to the effective magnetic resistance R_{g1} of the first air gap g₁.

Then, in general, when the effective magnetic resistance of the inductor is higher, the effective inductance is lower, and the width of the air gap is proportion to the magnetic resistance. Hence, when the width of the air gap is wider, the effective inductance of the inductor is lower, we can achieve the configuration of the different magnetic resistance R_{g1} and the magnetic resistance R_{g2} by adjusting the width of the first air gap g₁ and the second air gap g₂ to form the feature of the different effective inductance at the different current operations.

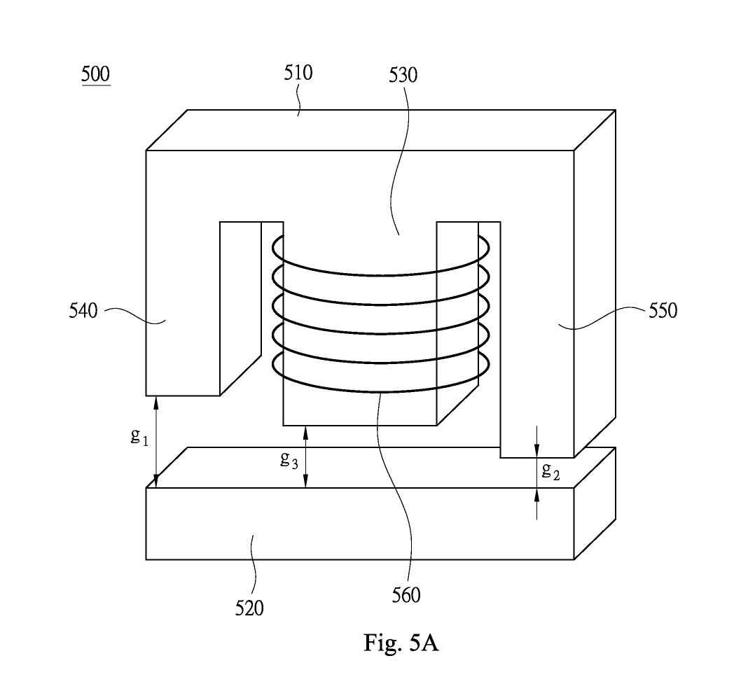

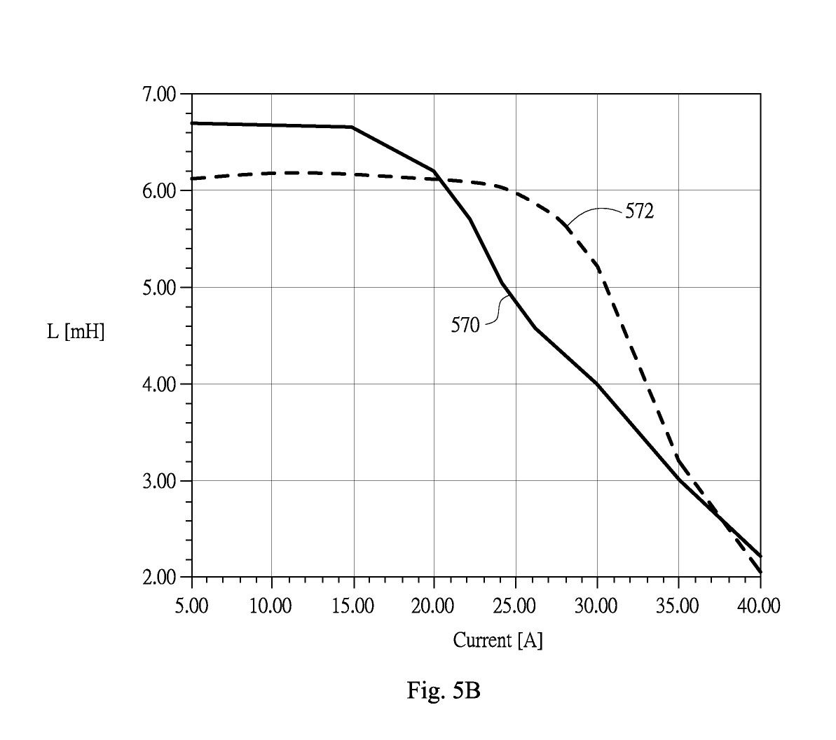

FIG. 5A is another configuration diagram of the nonlinear inductor as shown in FIG. 1 according to another embodiment in the present invention. All parts in the FIG. 5A are corresponding to the parts in the FIG. 1. As shown in the FIG. 5A, in this embodiment, the first air gap g₁ exists between the fourth magnetic core 540 and the second magnetic core 520, and the second air gap g₂ exists between the fifth magnetic core 550 and the second magnetic core 520, wherein the width of the first air gap g₁ and the second air gap g₂ are different, thereby forming the different first magnetic resistance and the second magnetic resistance. In this embodiment, the third magnetic core 530, the fourth magnetic core 540 and the fifth magnetic core 550 are directly connected to the first magnetic core 510. That is, the first magnetic core 510, the third magnetic core 530, the fourth magnetic core 540 and the fifth magnetic core 550 may be a one-piece magnetic element, and the magnetic element (the first magnetic core 510, the third magnetic core 530, the fourth magnetic core 540 and the fifth magnetic core 550) and the second magnetic core 520 roughly forms an E-I core. A third air gap g₃ exists between the third magnetic core 530 and the second magnetic core 520, wherein the first air gaps g₁ is wider than the third air gap g₃, and the third air gap g₃ is wider than the second air gap g₂.

For example, the width of the first air gap g₁ is about 1.35 mm, the width of the second air gap g₂ is about 0.45 mm, and the third air gap g₃ is about 0.9 mm. The corresponding diagram of the relation between the effective inductance and the current in this example is shown as the curve 570 with the solid line in the FIG. 5B. The curve 572 with the dotted line is used for comparison purpose. The curve 572 with the dotted line is indicative of the relation between the effective inductance and the current in the nonlinear inductor 500 as shown in FIG. 5A in which the widths of the air gaps are the same (about 0.9 mm). By referring the curve 570 with the solid line, the E-I core may achieve the high inductance at the low current operation and the low inductance at the high current operation by adjusting the different width of the air gaps.

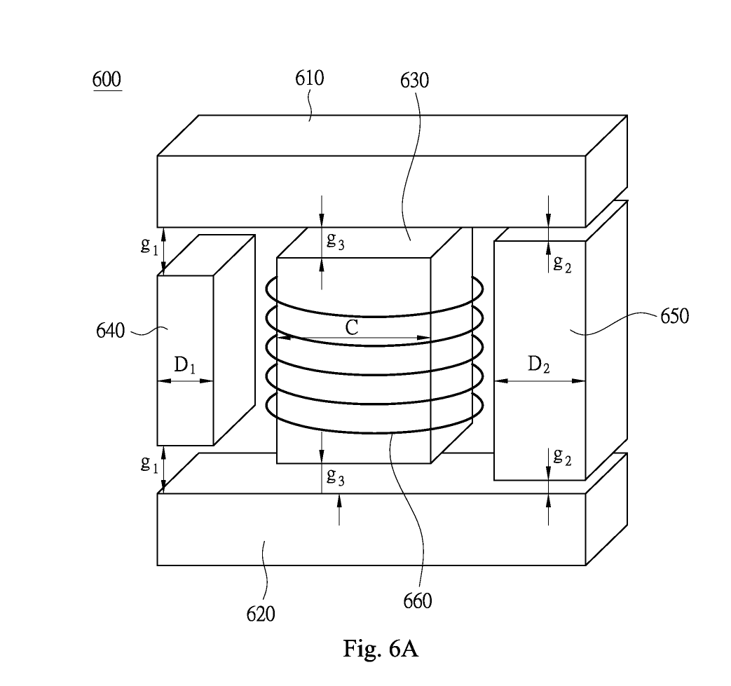

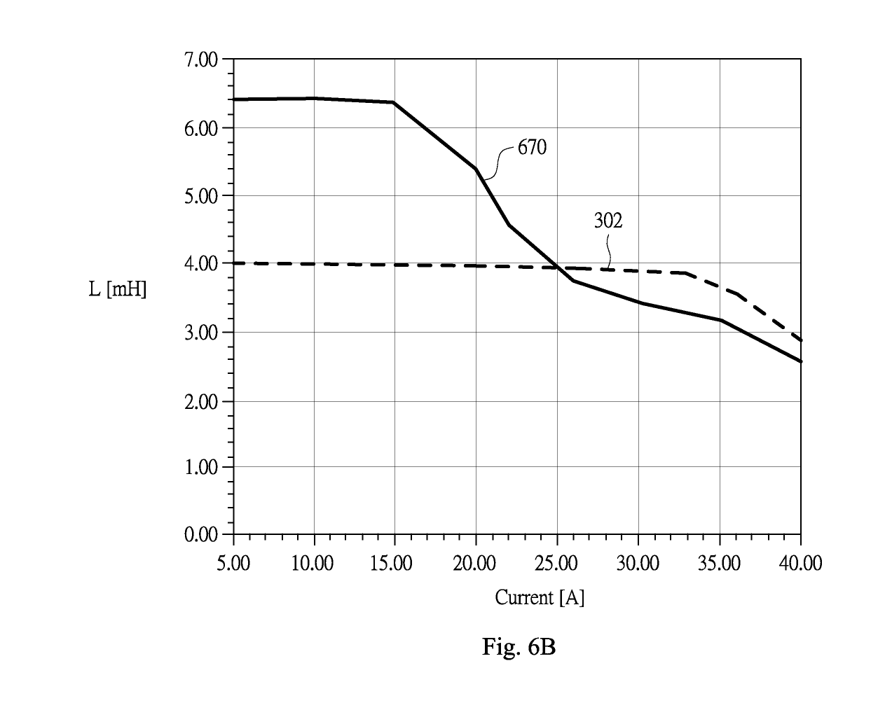

In addition, the magnetic resistance of the magnetic core is inversely proportional to the cross-sectional area of the magnetic core. In the condition of the different air gap, we can further adjust the amount of the magnetic resistance by adjusting the cross-sectional area of the magnetic core. For example, referring to the FIG. 6A, FIG. 6A is another configuration diagram of the nonlinear inductor as shown in FIG. 2 according to another embodiment in the present invention. All parts in the FIG. 6A are corresponding to the parts in the FIG. 2. As shown in FIG. 6A, in the condition of the different air gap, the width D₁ of the cross-sectional area of the fourth magnetic core 640 can be configured to be different from the width D₂ of the cross-sectional area of the fifth magnetic core 650 to generate the wider variation of the magnetic resistance, thereby achieving the different inductance range.

For example, as aforementioned description, the width of the first air gap g₁ may be about 0.9 mm, the width of the second air gap g₂ may be about 0.225 mm, and the width of the third air gap g₃ may be about 0.45 mm. The width D₁ of the cross-sectional area of the fourth magnetic core 640 may be about 22.2 mm, and the width D₂ of the cross-sectional area of the fifth magnetic core 650 may be about 33.3 mm. At this case, the corresponding diagram of the relation between the effective inductance and the current in this example is shown as the curve 670 with the solid line in the FIG. 6B. The curve 320 with the dotted line is used for comparison purpose. The inductance of the curve 320 with the dotted line is about 4mH at the low current operation, and the inductance of the curve 670 with the solid line is about 6.43mH at the low current operation. In summary, the variation of the inductance can be more by adjusting the width of the air gaps and the cross-sectional area of the magnetic cores in the same time.

Alternatively, taking the nonlinear inductor 500 as example, the third magnetic core 530, the fourth magnetic core 540 and the fifth magnetic core 550 are directly connected to the first magnetic core 510, and the third air gap g₃ exists between the third magnetic core 530 and the second magnetic core 520. At this case, the cross-sectional area of the fourth magnetic core 540 or the cross-sectional area of the fifth magnetic core 550 also can be further adjusted to achieve more variation within the first magnetic resistance and the second magnetic resistance and the different inductance range.

From the analysis of the equivalent magnetic circuit model shown in FIG. 4, the magnetic flux generated from the third magnetic core 230 and the coil unit 260 through which the current passed is shared by the fourth magnetic core 240 and the fifth magnetic core 250. Hence, we may increase the saturation magnetic flux to increase the utilization rate of the magnetic flux in the overall inductor.

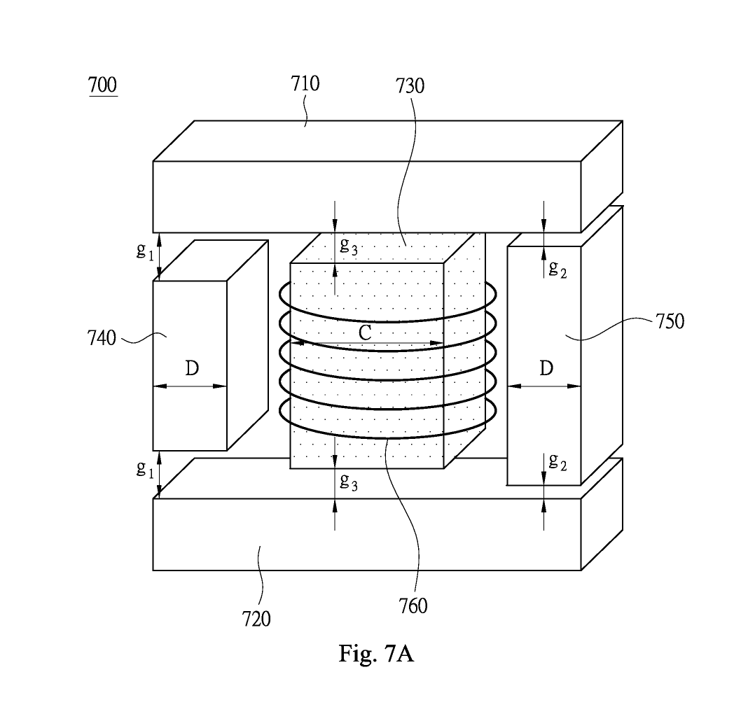

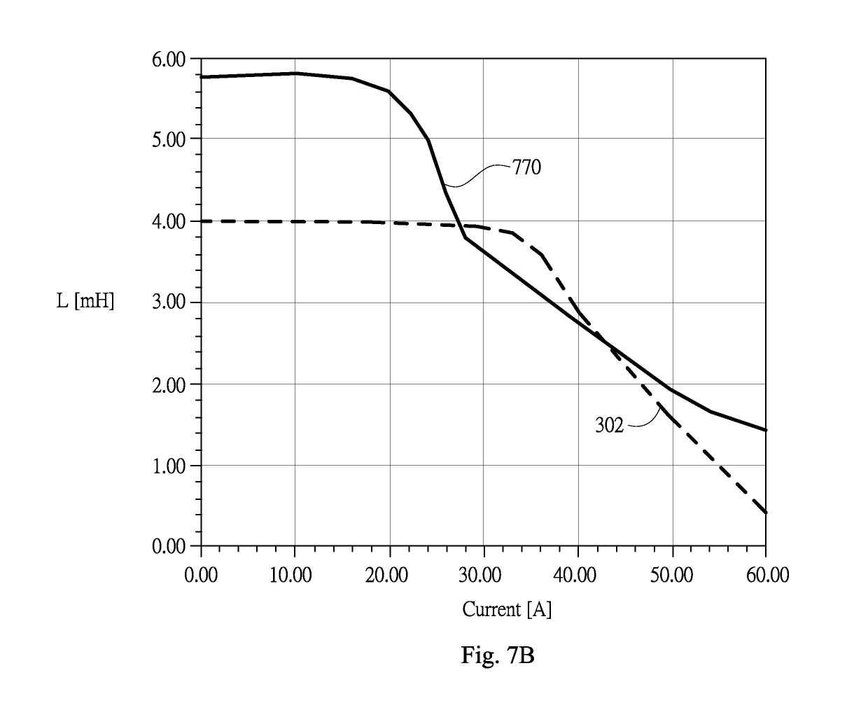

For example, referring to the FIG. 7A, FIG. 7A is another configuration diagram of the nonlinear inductor as shown in FIG. 1 according to another embodiment in the present invention. All parts in the FIG. 7A are corresponding to the parts in the FIG. 1. In some embodiments, the third magnetic core 730 is made of high performance magnetic materials. The first magnetic core 710, the second magnetic core 720, the fourth magnetic core 740 and the fifth magnetic core 750 are made of normal cores.

For example, as shown in FIG. 7A, the third magnetic core 730 is made of grain-orient electrical steel sheets, and the first magnetic core 710, the second magnetic core 720, the fourth magnetic core 740 and the fifth magnetic core 750 are made of non-oriented electrical steel sheets. The width of the first air gap g₁ may be about 0.9 mm, the width of the second air gap g₂ may be about 0.225 mm, and the width of the third air gap g₃ may be about 0.45 mm. At this case, the corresponding diagram of the relation between the effective inductance and the current in this example is shown as the curve 770 with the solid line in the FIG. 7B. Comparison with the aforementioned curve 302 with the dotted line, the saturation magnetic flux of the third magnetic core 730 can be increased in this configuration, and the different inductance can be achieved as well.

Notably, the above embodiments utilize an external support way between the magnetic cores to achieve the different configurations in the aforementioned description. For example, a support unit may exist between the magnetic cores to achieve the different configuration in accordance with the different embodiments and to save the cost of the air gap with extra mold opening.

The configurations in the above embodiments can be further utilized together in accordance with the specification of the practical application. For example, the cross-sectional areas of the magnetic cores and the widths of the air gaps can be adjusted in same time to achieve different inductance range.

In summary, the nonlinear inductor of the present invention has multiple ways to adjust the inductance without the extra mold opening to achieve the high inductance at the low current operation and the low inductance at the high current operation.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A nonlinear inductor, comprising:
a first magnetic core;
a second magnetic core, disposed in parallel with the first magnetic core;
a third magnetic core, vertically disposed between the first magnetic core and the second magnetic core;
a fourth magnetic core, vertically disposed between the first magnetic core and the second magnetic core;
a fifth magnetic core, vertically disposed between the first magnetic core and the second magnetic core, and the fourth magnetic core and the fifth magnetic being disposed at the sides of the third magnetic core; and
a coil unit, winding over the third magnetic core, wherein a DC current passes through the coil unit to generate an inductive magnetic flux, a first magnetic resistance of the fourth magnetic core passed through by the inductive magnetic flux is different from a second magnetic resistance of the fifth magnetic core passed through by the inductive magnetic flux.

2. The nonlinear inductor of claim 1, wherein a first air gap respectively exists between the fourth magnetic core and the first magnetic core and between the fourth magnetic core and the second magnetic core, and a second air gap respectively exists between the fifth magnetic core and the first magnetic core and between the fifth magnetic core and the second magnetic core, wherein the width of the first air gap and the second air gap is different, thereby forming the different first magnetic resistance and the second magnetic resistance.

3. The nonlinear inductor of claim 2, wherein a third air gap respectively exists between the third magnetic core and the first magnetic core and between the third magnetic core and the second magnetic core, wherein the first air gaps are wider than the third air gaps, and the third air gaps are wider than the second air gaps.

4. The nonlinear inductor of claim 1, wherein a first air gap exists between the fourth magnetic core and the second magnetic core, and a second air gap exists between the fifth magnetic core and the second magnetic core, the width of the first air gap is different from the width of the second air gap, thereby forming the different first magnetic resistance and the second magnetic resistance.

5. The nonlinear inductor of claim 4, wherein the third magnetic core, the fourth magnetic core and the fifth magnetic core are directly connected to the first magnetic core, and a third air gap exists between the third magnetic core and the second magnetic core, wherein the first air gap is wider than the third air gap, and the third air gap is wider than the second air gap.

6. The nonlinear inductor of claim 2, wherein the cross-sectional area of the fourth magnetic core is different from the cross-sectional area of the fifth magnetic core, thereby forming the different first magnetic resistance and the second magnetic resistance.

7. The nonlinear inductor of claim 3, wherein the cross-sectional area of the fourth magnetic core is different from the cross-sectional area of the fifth magnetic core, thereby forming the different first magnetic resistance and the second magnetic resistance.

8. The nonlinear inductor of claim 4, wherein the cross-sectional area of the fourth magnetic core is different from the cross-sectional area of the fifth magnetic core, thereby forming the different first magnetic resistance and the second magnetic resistance.

9. The nonlinear inductor of claim 5, wherein the cross-sectional area of the fourth magnetic core is different from the cross-sectional area of the fifth magnetic core, thereby forming the different first magnetic resistance and the second magnetic resistance.

10. The nonlinear inductor of claim 1, wherein the third magnetic core is made of grain-orient electrical steel sheets, and the first magnetic core, the second magnetic core, the fourth magnetic core and the fifth magnetic core are made of non-orient electrical steel sheets.

11. A nonlinear inductor, comprising:
a first magnetic core;
a second magnetic core, disposed in parallel with the first magnetic core;
a third magnetic core, vertically disposed between the first magnetic core and the second magnetic core;
a coil unit, winding around the third magnetic core;
a fourth magnetic core, vertically disposed between the first magnetic core and the second magnetic core; and
a fifth magnetic core, vertically disposed between the first magnetic core and the second magnetic core, and the forth magnetic core and the fifth magnetic being disposed at the sides of the third magnetic core,
wherein a first air gap respectively exists between the fourth magnetic core and the first magnetic core and between the fourth magnetic core and the second magnetic core, a second air gap respectively exists between the fifth magnetic core and the first magnetic core and between the fifth magnetic core and the second magnetic core, and a third air gap exists respectively between the third magnetic core and the first magnetic core and between the third magnetic core and the second magnetic core, wherein the first air gaps are wider than the third air gaps, and the third air gaps are wider than the second air gaps.

12. A nonlinear inductor, comprising:
a first magnetic core;
a second magnetic core, disposed in parallel with the first magnetic core;
a third magnetic core, vertically disposed between the first magnetic core and the second magnetic core;
a coil unit, winding around the third magnetic core;
a fourth magnetic core, vertically disposed between the first magnetic core and the second magnetic core; and
a fifth magnetic core, vertically disposed between the first magnetic core and the second magnetic core, and the forth magnetic core and the fifth magnetic being disposed at the sides of the third magnetic core,
wherein the cross-sectional area of the fifth magnetic core is larger than the cross-sectional area of the fourth magnetic core, a first air gap respectively exists between the fourth magnetic core and the first magnetic core and between the fourth magnetic core and the second magnetic core, a second air gap respectively exists between the fifth magnetic core and the first magnetic core and between the fifth magnetic core and the second magnetic core, and a third air gap respectively exists between the third magnetic core and the first magnetic core and between the third magnetic core and the second magnetic core, wherein the first air gaps are wider than the third air gaps, and the third air gaps are wider than the second air gaps.

13. A nonlinear inductor, comprising:
a first magnetic core;
a second magnetic core, disposed in parallel with the first magnetic core;
a third magnetic core, directly connected to the first magnetic core, vertically disposed between the first magnetic core and the second magnetic core;
a fourth magnetic core, directly connected to the first magnetic core, vertically disposed between the first magnetic core and the second magnetic core;
a fifth magnetic core, directly connected to the first magnetic core, vertically disposed between the first magnetic core and the second magnetic core, and the forth magnetic core and the fifth magnetic being disposed at the sides of the third magnetic core; and
a coil unit, winding the third magnetic core,
wherein a first air gap exists between the fourth magnetic core and the second magnetic core, a second air gap exists between the fifth magnetic core and the second magnetic core, and a third air gap exists between the third magnetic core and the second magnetic core, wherein the first air gap is wider than the third air gap, and the third air gap is wider than the second air gap.
